(19) United States
(12) Patent Application Publication
(10) Pub. No.: US 2007/0046610 A1
(43) Pub. Date: Mar. 1, 2007

(54) Driving method for display apparatus

(75) Inventor: Noboru Okuzono, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kanagawa (JP)

(21) Appl. No.: 11/500,380

(22) Filed: Aug. 8, 2006

(30) Foreign Application Priority Data
Sep. 1, 2005 (JP) 2005-253246

(51) Int. Cl. G09G 3/36

(52) U.S. Cl. 345/96

(57) ABSTRACT

A driving method for a display apparatus including a plurality of pixels arranged in matrix along a line direction and a column direction implements sequential driving in the column direction by inverting a polarity of a plurality of pixels arranged in the line direction. The method includes driving a plurality of pixels arranged in an odd line, and driving a plurality of pixels arranged in an even line and in a column different from a column of the plurality of driven pixels in the odd line.

### BACKGROUND OF THE INVENTION

1. Field of the Invention

The present invention generally relates to a driving method for a display apparatus and particularly relates to a driving method for a display apparatus such as a liquid crystal display apparatus.

2. Description of Related Art

An active matrix liquid crystal display apparatus (AMLCD) has a plurality of pixels arranged in matrix, each pixel having an active device such as a thin film transistor (TFT). A gate electrode of each active device is connected to a scan line along a row direction (referred to herein also as the “line” direction), and a drain electrode of each active device is connected to a data line along a column direction.

Linear-sequential scanning is a technique used for display in a liquid crystal display apparatus. The linear-sequential scanning scans a scan line sequentially from top to bottom or from bottom to top of a display panel, thereby displaying a single image on a panel. The single image may be referred to as a frame or a field.

In such a liquid crystal display apparatus, the polarity of a voltage (referred to herein as a pixel voltage) that is applied to a pixel through a data line and TFT is inverted every prescribed period in order to suppress deterioration of liquid crystal materials. The driving method that drives pixels while inverting the polarity is well known as dot inversion driving. The polarity of a pixel voltage indicates positive or negative of a pixel voltage on the basis of a voltage of a common electrode (common voltage) of liquid crystals.

For example, the method may drive one scan line by inverting the polarity of a pixel voltage for each pixel (column). Specifically, it may drive one scan line with one polarity and then drive the next line with an opposite polarity of all corresponding pixels. In the next frame, those pixels may be driven at an opposite polarity. The dot inversion driving enables display of almost all images without the occurrence of flicker or interference between adjacent pixels.

However, there exists a drawback that flicker appears on an image with a specific pattern such as a striped pattern and checked pattern. Further, with recent trends of larger pixel size and higher definition, data of a liquid crystal panel or a load on a gate electrode are on the increase, which causes an increase in parasitic capacitance of drain lines. Therefore, the technique of inverting the polarity for each column or line such as the dot inversion requires significant power consumption. This is described in detail with reference to FIGS. 5 to 7.

FIG. 5 illustrates an example of a driving state according to a conventional dot inversion technique. FIG. 5 shows a square inversion that is an example of the dot inversion driving. The square inversion is developed in order to reduce power consumption and avoid flicker that appears in a specific pattern such as a checked pattern.

The timing chart of FIG. 6 shows the drive timing in the dot inversion driving that is shown in FIG. 5. As shown in FIG. 6, if a load on a liquid crystal panel is heavy, a data electrode is charged and discharged at the changeover of polarities, which causes write defect to occur. In FIG. 6, a signal waveform in the event of write defect is indicated by alternate long and short dashed lines.

As shown in FIG. 6, write defect occurs in the voltage of display data that is held in the lines 1 and 3. Thus, the lines 1 and 3 and the lines 2 and 4 are respectively arranged crosswise in succession with different hold levels, and a vertical difference in luminance appears as a striped pattern on display.

In order to address this concern, there is a technique that provides output short-circuit when the polarity of display data is the same in succession. The timing chart of FIG. 7 shows drive timing in the improved dot inversion driving.

This technique short-circuits outputs each line to once return a write level to a common level, thereby holding all liquid crystal cells at a write defect level. This eliminates a vertical difference in luminance in liquid crystal cells and a striped pattern ceases to appear. However, this approach causes the overall display to have deteriorated display characteristics of a liquid crystal panel. Further, because the outputs are short-circuited for all lines, a source driver needs charging and discharging of a data electrode for every line. This significantly reduces the effect of low power consumption, which is an advantage of the square inversion.

It is possible to perform two-line inversion driving in order to reduce power consumptions. Still, current consumption increases due to the output short-circuit provided for each line to avoid uneven display with a striped pattern. Further, in spite of the two-line inversion driving, the voltage of the tone at which all liquid crystal cells are held does not reach a final level and thus the uneven display with a striped pattern cannot be suppressed sufficiently.

As a technique for overcoming the drawback of high power consumption, Japanese Unexamined Patent Application Publication No. 05-048056 discloses a method of driving a plurality of columns or lines with the same polarity.

According to the method disclosed in Japanese Unexamined Patent Application Publication No. 05-048056, the pixels in the same column in two successive lines may have the same or different polarity, and the charge amounts to respective pixels may differ. If parasitic resistance and parasitic capacitance increase due to an increase in display size or a charge time per line decreases due to an increase in the total number of pixels, a difference in charge amount occurs between pixels depending on whether the polarity differs from a pixel in the previous line or not, which appears as a luminance difference that is recognized as a stripe pattern in the row direction.

Techniques for overcoming such a drawback are disclosed in Japanese Unexamined Patent Application Publications Nos. 11-337975, 2004-061590, and 2001-215469, for example.

A technique disclosed in Japanese Unexamined Patent Application Publication No. 2001-215469 charges a pixel by delaying the timing to turn ON a gate waveform in the n-th line in which the polarity of a drain line is switched from the start of a change in the drain line. Further, the technique maintains the ON state in the (n+1)-th line having the same polarity as the n-th line for the same time period as in the n-th line, thereby equalizing the charge amount to pixels in the line (n-th line) where the polarity differs from the previous line and the line ((n+1)-th line) where the polarity stays the same. This prevents the luminance from varying between lines.

In this manner, the techniques of related arts reduce the period to maintain ON-state of agate in the line where the polarity stays the same as the previous line by delaying the timing to turn ON the gate or extending the ON-period of a gate in the line where the polarity differs from the previous line, thereby preventing the luminance from varying between lines.

A time period to maintain ON-state of a gate for displaying a single line is restricted by an input signal. Further, a difference in luminance cannot be eliminated in a panel having large load capacitance, a high definition panel in which a write period per line is short and so on. If a technique that eliminates a difference in luminance by shortening an ON-state period of a gate is employed, it is impossible to use maximum luminance in a line where the polarity stays the same, resulting in low contrast display.

As described in the foregoing, the present invention has recognized that the driving method for a liquid crystal display apparatus of related arts cannot achieve both suppression of luminance variation and reduction of power consumption.

### SUMMARY OF THE INVENTION

According to an aspect of the present invention, there is provided a driving method for a display apparatus including a plurality of pixels arranged in matrix along a line direction and a column direction, which implements sequential driving in the column direction by inverting a polarity of a plurality of pixels arranged in the line direction. The method includes driving a plurality of pixels arranged in an odd line, and driving a plurality of pixels arranged in an even line and in a column different from a column of the plurality of driven pixels in the odd line.

According to an aspect of the present invention, there is provided a display apparatus including a plurality of pixels arranged in matrix along a line direction and a column direction, a plurality of driver connected to the plurality of pixels and capable of driving the plurality of pixels, and a controller for driving a plurality of pixels arranged in the line direction sequentially in the column direction by inverting a polarity of the pixels, the controller driving a plurality of pixels arranged in an odd line, and driving a plurality of pixels arranged in an even line and in a column different from a column of the plurality of driven pixels in the odd line.

### BRIEF DESCRIPTION OF THE DRAWINGS

The above and other objects, advantages and features of the present invention will be more apparent from the following description taken in conjunction with the accompanying drawings, in which:

FIG. 1A is a pattern diagram showing an example of driving state of a liquid crystal display apparatus according to an embodiment of the present invention;

FIG. 1B is a pattern diagram showing an example of driving state of a liquid crystal display apparatus according to an embodiment of the present invention;

FIG. 1C is a pattern diagram showing an example of driving state of a liquid crystal display apparatus according to an embodiment of the present invention;

FIG. 1D is a pattern diagram showing an example of driving state of a liquid crystal display apparatus according to an embodiment of the present invention;

FIG. 1E is a pattern diagram showing an example of driving state of a liquid crystal display apparatus according to an embodiment of the present invention;

FIG. 1F is a pattern diagram showing an example of driving state of a liquid crystal display apparatus according to an embodiment of the present invention;

FIG. 1G is a pattern diagram showing an example of driving state of a liquid crystal display apparatus according to an embodiment of the present invention;

FIG. 1H is a pattern diagram showing an example of driving state of a liquid crystal display apparatus according to an embodiment of the present invention;

FIG. 2A is a pattern diagram showing an exemplary structure of a liquid crystal display apparatus according to an embodiment of the present invention;

FIG. 2B is a pattern diagram showing an exemplary structure of a liquid crystal display apparatus according to an embodiment of the present invention;

FIG. 3 is a timing chart showing an example of drive timing of a liquid crystal display apparatus according to an embodiment of the present invention;

FIG. 4 is a timing chart showing another example of drive timing of a liquid crystal display apparatus according to an embodiment of the present invention;

FIG. 5 is a pattern diagram showing an example of driving state of a liquid crystal display apparatus according to a related art;

FIG. 6 is a timing chart showing an example of drive timing of a liquid crystal display apparatus according to a related art; and

FIG. 7 is a timing chart showing another example of drive timing of a liquid crystal display apparatus according to a related art.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A display apparatus according to exemplary embodiments of the present invention is driven by an inversion driving method that drives a plurality of columns or lines at the same polarity.

Exemplary embodiments of the present invention are described hereinafter with reference to the drawings. Though embodiments of the present invention are described below by way of example in which an active matrix liquid crystal display apparatus is employed, the present invention is not limited thereto and applicable to any display apparatus capable of inversion driving that sets the pixels arranged in a plurality of columns and lines to the same polarity.

### First Embodiment

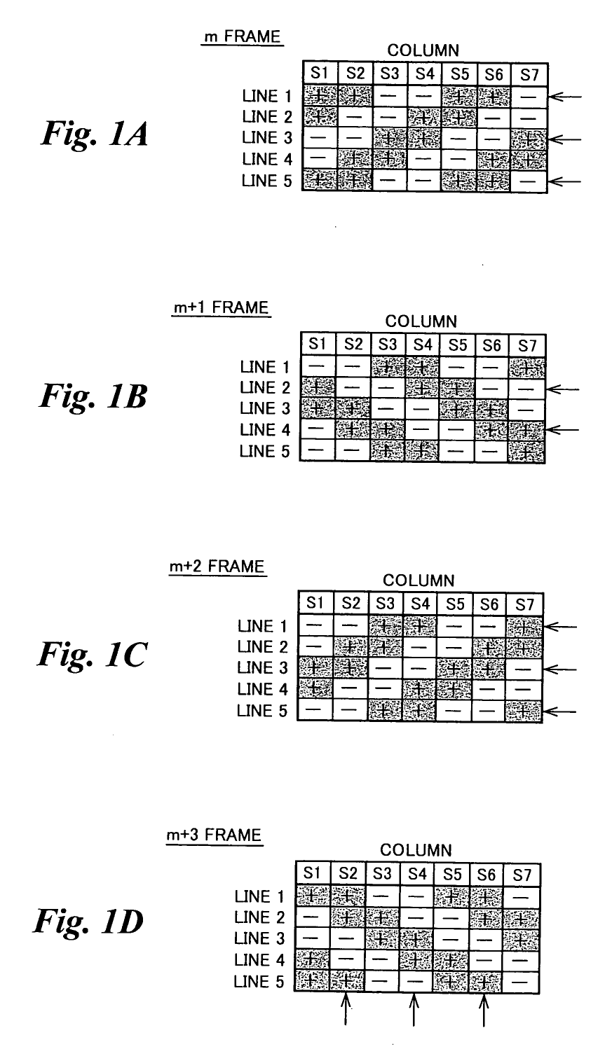

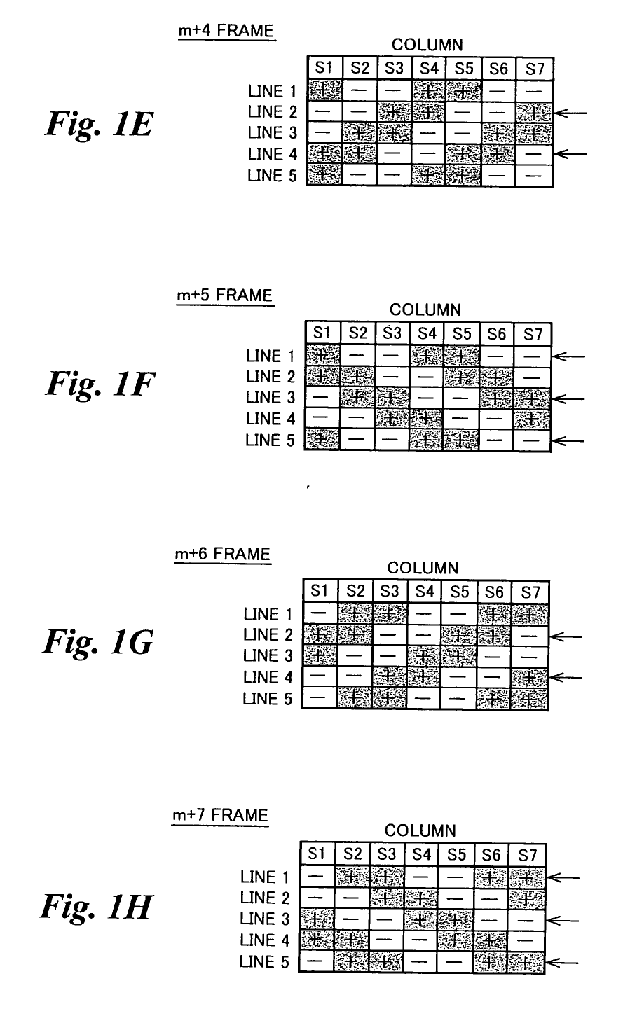

Inversion driving of pixels that is implemented in a liquid crystal display apparatus according to an exemplary embodiment of the invention is described schematically with reference to FIGS. 1A to 1H. FIGS. 1A to 1H are pattern diagrams showing an example of driving state of a liquid crystal display apparatus according to this embodiment. In FIGS. 1A to 1H, the shadowed dot “+” is driven to a positive value, and the non-shaded dot “−” is driven to a negative value. Also in FIGS. 1A to 1H, the symbol “←” indicates the next row (line) to be inversion-driven, and “↑” indicates the next column to be inversion-driven.

Referring first to FIG. 1A, the dots in the lines 1 to 4 are driven to positive and negative values in the m frame. Referring next to FIG. 1B, when the m frame shifts to the m+1 frame, the dots in the lines 1, 3 and 5 are driven to inverted values. Referring further to FIGS. 1C and 1D, the m+1 frame further shifts to the m+2 frame and the m+3 frame in succession. In each process of shifting, the dots in the lines 2 and 4, and the dots in the lines 1, 3, and 5, respectively, are driven to inverted values.

When the m+3 frame shifts to the m+4 frame, if the dots in the lines 2 and 4 are driven to inverted values, the frame would return to the state of the m frame. However, this embodiment does not allow the m+4 frame to return to the m frame so as to diversify the driving patterns. Specifically, when the m+3 frame shifts to the m+4 frame, the dots in the column direction are driven to inverted values. In detail, the dots in the 2nd, 4th, and 6th columns are driven to inverted values. After that, referring to FIGS. 1F and 1G, when the the m+4 frame shifts to the m+5 frame, the dots in the lines 2 and 4 are driven to inverted values, and when the the m+5 frame shifts to the m+6 frame, the dots in the lines 1, 3 and 5 are driven to inverted values, respectively. Referring finally to FIG. 1H, when the m+6 frame shifts to the m+7 frame, the dots in the lines 2 and 4 are driven to inverted values. Then, the dots in the lines 1, 3 and 5 are driven to inverted values in the m+7 frame so that the frame returns to the m frame.

A liquid crystal display apparatus according to an exemplary embodiment of the present invention is described hereinafter.

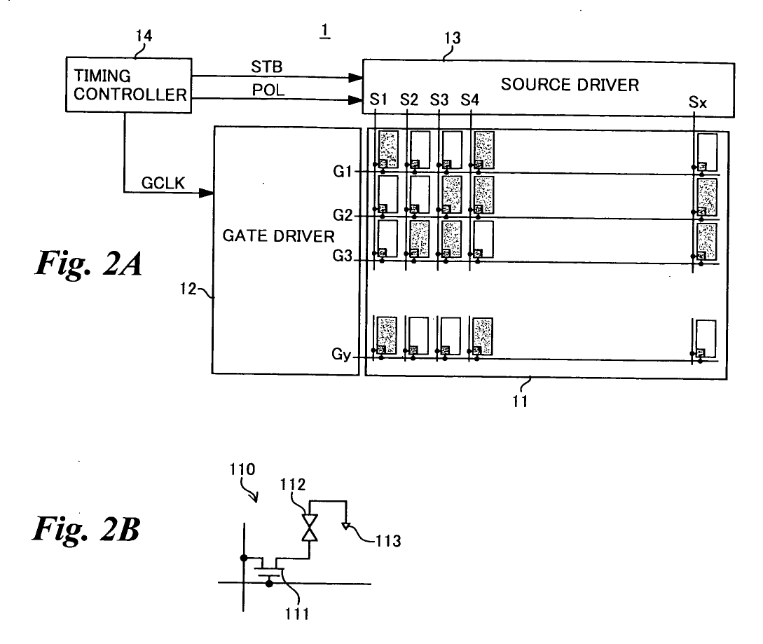

Referring now to FIGS. 2A and 2B, the structure of the liquid crystal display apparatus of this embodiment is described herein with reference to FIGS. 2A and 2B. FIG. 2A is a pattern diagram showing an exemplary structure of the liquid crystal display apparatus of this embodiment.

FIG. 2A illustrates main components of the liquid crystal display apparatus of this embodiment. As shown in FIG. 2A, the liquid crystal display apparatus 1 includes a liquid crystal panel 11, a gate driver 12, a source driver 13, and a timing controller 14.

The liquid crystal panel 11 has a number of pixels 110 that are arranged in matrix. Specifically, the pixels 110 are arranged in the crossing positions of a plurality of gate lines G1 to Gy in the row direction (referred to also as the line direction or the scan line direction) and a plurality of source lines S1 to Sx in the column direction. FIG. 2B illustrates a specific structure of the pixel 110 in the liquid crystal panel 11.

As shown in FIG. 2B, each pixel 110 includes a TFT transistor 111, a liquid crystal cell capacitor 112, and a common electrode 113.

The TFT transistor 111 is an example of an active device. Each TFT transistor 111 has a gate terminal that is connected to the gate lines G1 to Gy in the line direction, a source terminal that is connected to the source lines S1 to Sx in the column direction, and a drain terminal that is connected to one end of the liquid crystal cell capacitor 112.

The liquid crystal cell capacitor 112 has a capacitor for storing a write voltage that is supplied through the source lines S1 to Sx and the TFT transistor 111. The luminance of each pixel 110 is determined in accordance with the level of the write voltage to the liquid crystal cell capacitor 112. The terminals of the liquid crystal cell capacitor 112 are respectively connected to the drain terminal of the TFT transistor 111 and the common electrode 113.

The common electrode 113 is supplied with a reference voltage (common voltage) for determining the polarity (positive or negative) of a write voltage to the liquid crystal cell capacitor 112.

In the pixel 110, when a drive voltage is applied to any of the gate lines G1 to Gy, the TFT transistor 111 which is connected to the activated gate line is turned ON. Then, the write voltage of picture data that is supplied through the source lines S1 to Sx is applied to the liquid crystal cell capacitor 112 which is connected to the TFT transistor 111 to thereby charge the capacitor.

If no voltage is applied to the gate lines G1 to Gy, the TFT transistor 111 is OFF. The liquid crystal cell capacitor 112 retains the write voltage for one frame period until the writing is performed again. The retention voltage enables continuous display on the liquid crystal panel 11.

The output of the gate driver 12 is connected to the gate electrode of the TFT transistor 111. Specifically, the gate driver 12 supplies a drive voltage sequentially to the gate lines G1 to Gy to thereby control ON/OFF of the TFT transistor 111 which is connected to the gate lines G1 to Gy. The drive voltage supplied from the gate driver 12 through the gate lines G1 to Gy turns ON the gate of the TFT transistor 111 of each pixel 110.

The output of the source driver 13 is connected to the source electrode of the TFT transistor 111 that is connected to the data line on the liquid crystal display panel. Specifically, the source driver 13 supplies a write voltage to the source lines S1 to Sx to thereby perform writing to the liquid crystal cell capacitor 112 through the TFT transistor 111 that is driven by the gate driver 12.

When the gate driver 12 turns ON the TFT transistor 111 of each pixel 110 and if the source driver 13 supplies a write voltage to the source lines S1 to Sx, the liquid crystal cell capacitor 112 which is connected to each TFT transistor 111 is charged. At this time, the change having the polarity in accordance with the polarity of the write voltage applied to the source lines S1 to Sx is supplied to the liquid crystal cell capacitor 112. Thus, if the positive write voltage is applied to the source lines S1 to Sx, a positive charge is supplied to the liquid crystal cell capacitor 112; if the negative write voltage is applied to the source lines S1 to Sx, a negative charge is supplied to the liquid crystal cell capacitor 112.

The timing controller 14 supplies various control signals to the gate driver 12 and the source driver 13 to control the driving of each pixel 110. Specifically, the timing controller 14 outputs a strobing signal (STB), a polarity inversion signal (POL), and a shift clock (GCLK).

The strobing signal is a signal for latching picture data to an internal register and it is input to the source driver 13. The polarity inversion signal is a signal for controlling the selection of positive or negative level relative to a common voltage and it is also input to the source driver 13. The shift clock is a timing signal for shifting a gate pulse, and it is input to the gate driver 12. In addition to those signals, there are other inputs such as picture data and clock in the structure shown in FIGS. 2A and 2B, though they are not illustrated therein.

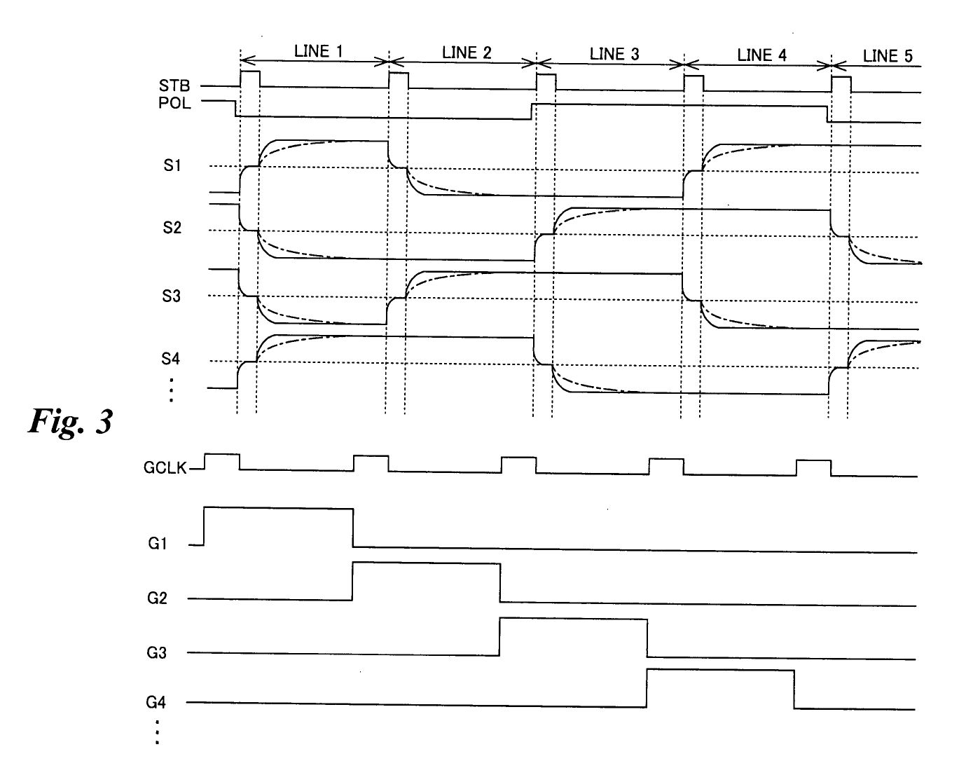

The inversion driving that is implemented in the liquid crystal display apparatus 1 of this embodiment is described in detail below with reference to FIG. 3. FIG. 3 is a timing chart showing the drive timing of polarity inversion in the liquid crystal display apparatus 1. FIG. 3 illustrates the inverted state in FIG. 1E.

On the rising edge of the clock signal GCLK that is input to the gate driver 12, a drive voltage is applied to the gate line G1 in the first row. The pixels 110 in the first row that are connected to the gate line G1 are thereby selected. A write voltage corresponding to the picture data on the gate line G1 in the first row is applied to the source lines S1, S2 and so on. The liquid crystal cell capacitor 112 that is connected to the gate line G1 in the first, second and subsequent rows thereby enter a writable state for picture data.

The strobing signal rises with the gate line G1 in the first row being selected. The polarity inversion signal falls from High to Low while the strobing signal is High, and thereby the source driver 13 short-circuits the outputs. The output short-circuit is the state in which the outputs of the source driver 13 are electrically connected to each other by an internal switch. Therefore, under the state of the output short-circuit, because the number of ON lines outputting a positive voltage and the number of ON lines outputting a negative voltage in the source driver 13 are the same, they cancel each other, and the voltage of the source electrode of the liquid crystal panel changes to a common level.

The source lines S1, S2 and so on are supplied with the write voltages of positive, negative, negative, positive . . . polarities in sequence. The liquid crystal cell capacitor 112 that is connected to the source lines are thereby charged with positive, negative, negative, positive . . . charges. Each pixel 110 in the first row is thereby driven to positive, negative, negative, positive . . . values sequentially in the column direction. The output polarities of the pixels 110 in the line 1 are thus “+”, “−”, “−”, “+”, . . . sequentially from S1 in the column direction.

On the rising edge of the clock signal GCLK that is input to the gate driver 12, a drive voltage is applied to the gate line G2 in the second row. The pixels 110 in the second row that are connected to the gate line G2 thereby enter a writable state for picture data. The strobing signal rises, and the polarity inversion signal stays the same during the High period of the strobing signal. The output of the source driver 13 is thereby high impedance, so that the polarity of the write voltage that is applied to the source lines S1, S3 and so on in the odd columns becomes invertible.

For example, the liquid crystal cell capacitor 112 that is connected to the source line S1 is charged with positive values before the inversion. In order to charge negative values to the liquid crystal cell capacitor 112, the positive charges on the liquid crystal cell capacitor 112 are discharged. Thus, on the falling edge of the strobing signal, the voltage applied to the source line S1 falls slowly from the positive write voltage to the reference voltage.

After that, the voltage applied to the source line S1 rises slowly from the reference voltage to the negative write voltage. The liquid crystal cell capacitor 112 that is connected to the source line S1 is thereby charged with negative values, so that the polarity of the pixels 110 in the first row is inverted from positive to negative. In this manner, the polarity of the pixels 110 that are connected to the source lines S1, S3 and so on in the odd columns are inverted. Consequently, the output polarity of the pixels 110 in the line 2 is “−”, “−”, “+”, “+”, . . . sequentially from S1 in the column direction.

The output polarity of the pixels 110 in the line 3 is inverted in the same manner. Specifically, the strobing signal rises with the gate line G3 in the third row being selected. Then, the polarity inversion signal rises from Low to High while the strobing signal is High, and thereby the source driver 13 short-circuits the outputs. As a result, the polarity of the write voltage that is applied to the source lines S2, S4 and so on in the even columns is inverted. Thus, the output polarity of the pixels 110 in the line 3 is “−”, “+”, “+”, “−”, . . . sequentially from S1 in the column direction. The polarity is inverted in the same manner in the line 4 as well, and thereby the line 5 is driven at the same polarity as the line 1.

The timing chart of FIG. 3 indicates the outputs of the source driver 13 in the event of write defect by alternate long and short dashed lines. As shown in FIG. 3, if a load (resistance and capacitance) on the liquid crystal panel 11 is heavy, and the output waveform of the source driver 13 is rounded, the point when the output voltage rises to a final level delays. This can cause a charge amount to the pixel 110 to differ from the line where no polarity inversion occurs.

As shown in FIG. 3, if a load on the liquid crystal panel 11 is heavy, it is sometimes unable to write to a sufficient level during one horizontal period corresponding to the lines 1, 2, 3, 4 and so on. Particularly, when resolution is as low as 10 μs in a UXGA panel, the writing cannot be done sufficiently in some cases. In the example of FIG. 3, charge/discharge of the source electrode occurs in the line 3, the gate lines S1 and S3 of the lines 2 and 4, the gate lines S2 and S4 of the lines 3 and 5 due to the switching of the polarity inversion signal, causing the voltage to be held at a write defect level.

As described in the foregoing, according to the driving method of this embodiment, the pixel 110 where write defect is occurring and the pixel 110 where write defect is not occurring are not vertically or horizontally adjacent to each other. For example, in the line 2 of FIG. 3, while the write defect occurs in the pixel 110 in the first and third rows, it does not occur in the pixel 110 in the second and fourth rows. In the line 3, while the write defect occurs in the pixel 110 in the second and fourth rows, it does not occur in the pixel 110 in the first and third rows. It is thereby possible to prevent the occurrence of luminance variation with a striped pattern, thus avoiding uneven display.

Further, the driving method of this embodiment does not short-circuit the outputs if a polarity inversion signal stays the same such as the polarity inversion in the line 2. This prevents an increase in current consumption and thus enables reduction of power consumption. Therefore, this embodiment can achieve both suppression of luminance variation and reduction of power consumption.

Furthermore, in the liquid crystal display apparatus 1 of this embodiment, not all the liquid crystal cell capacitors 112 are held at a write defect level, and the liquid crystal cell capacitors 112 in the pixels 110 where the polarity is not inverted are charged to a sufficient level. Thus, though it is different from the polarity inversion driving method of conventional square inversion, it is possible to reduce flicker that occurs in specific display patterns such as a checked pattern just like the conventional square inversion.

### Second Embodiment

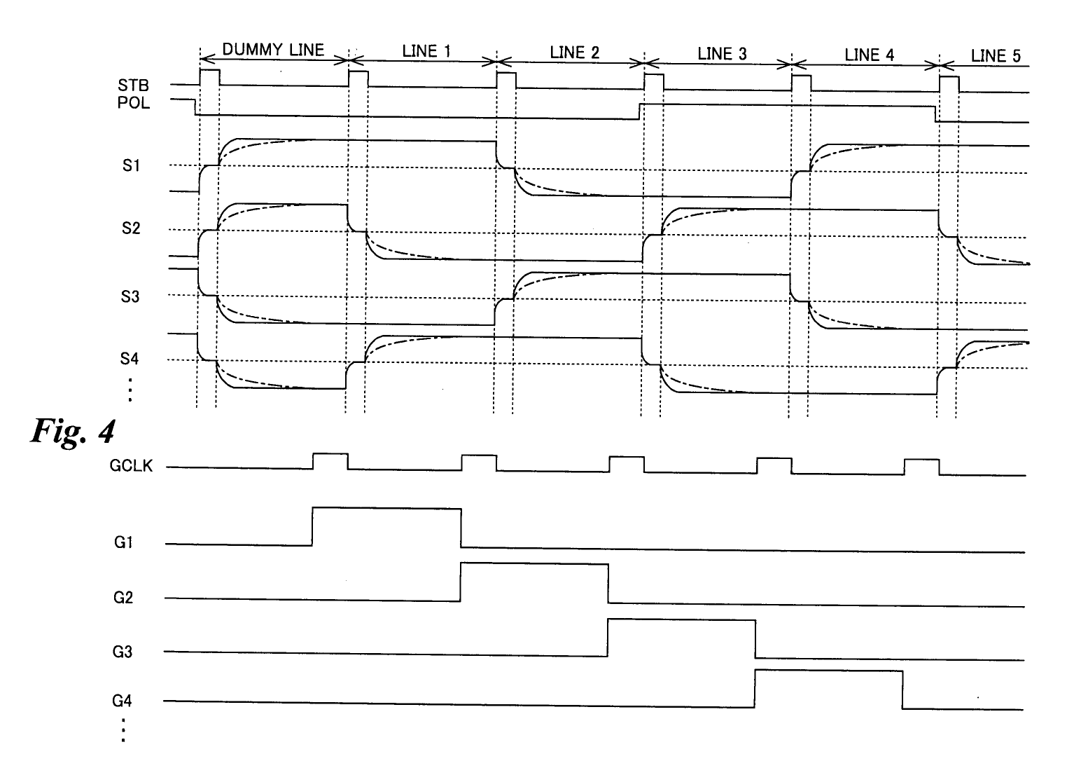

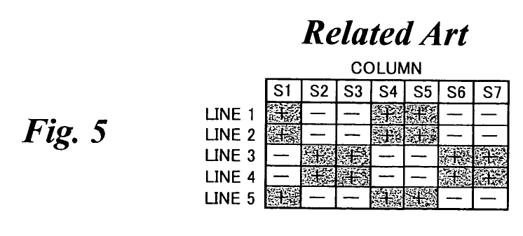

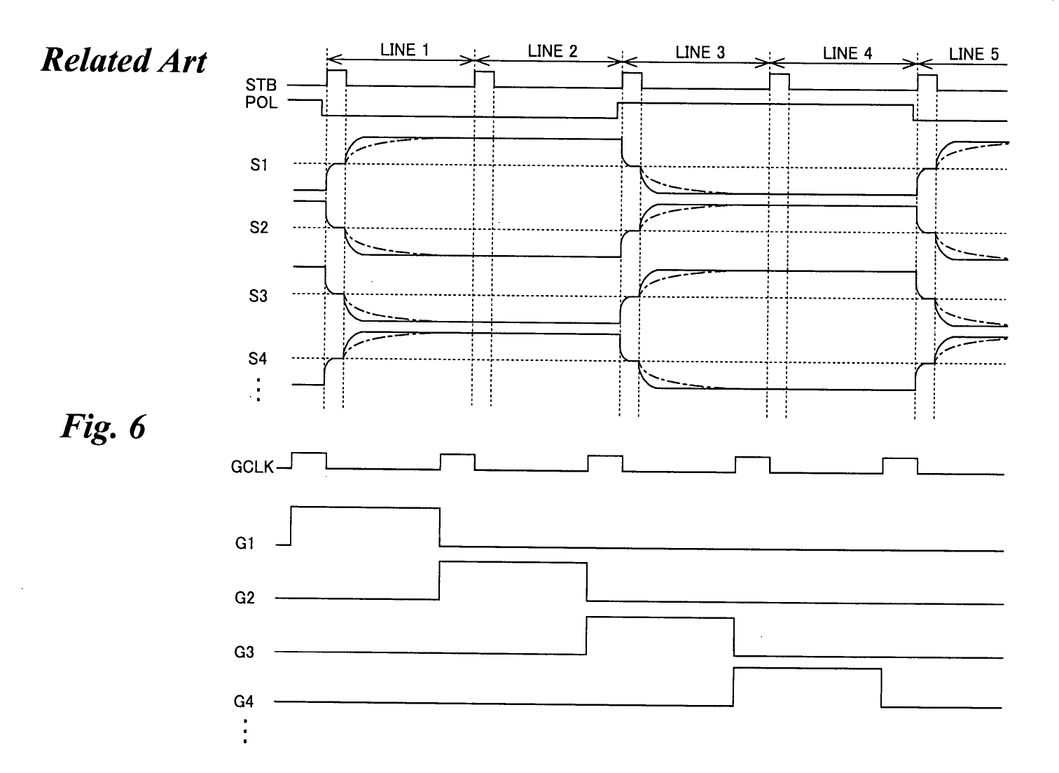

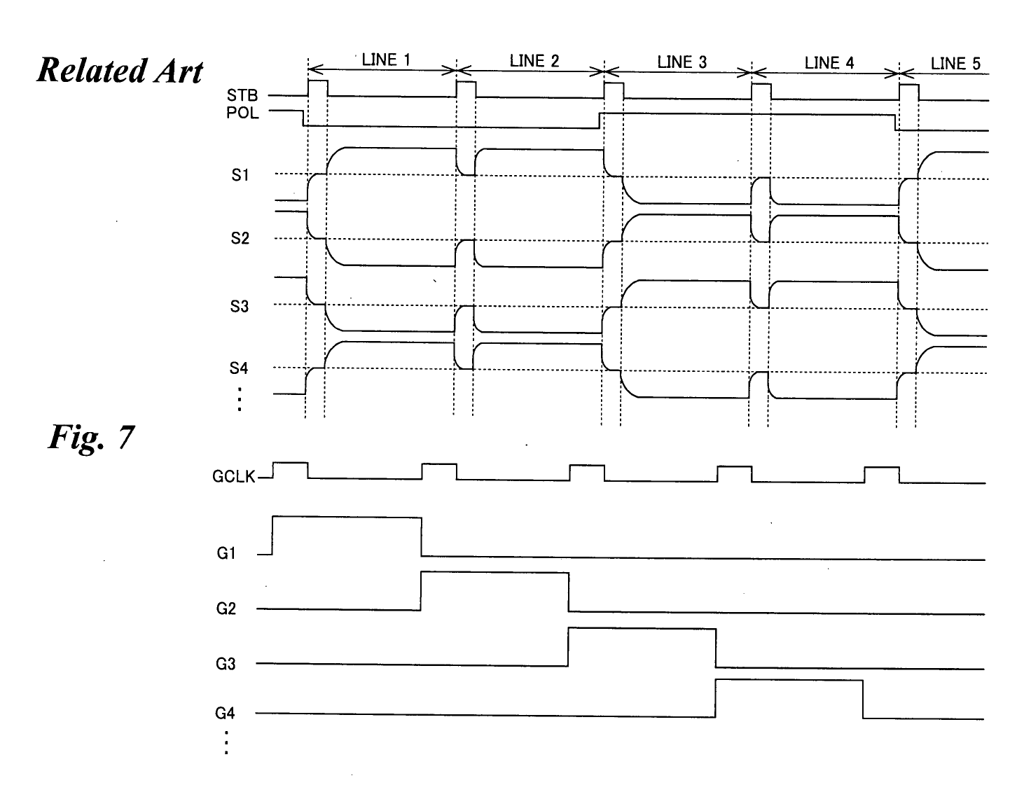

In the first embodiment described above, write defect can still occur in the line 1 as shown in FIG. 3. Thus, the line 1 can be recognized as horizontal stripes in the first embodiment. To address this concern, the second embodiment suppresses the occurrence of write defect in the line 1. FIG. 4 shows a timing chart in this embodiment.

As shown in FIG. 4, the liquid crystal display apparatus 1 of this embodiment includes a dummy line. The dummy line is composed of dummy pixels that do not contribute to display, which is different from the pixels 110. The dummy line is connected to the source driver 13 in the same manner as the source lines S1 to Sx and supplies a write voltage to the liquid crystal cell capacitor 112. As shown in FIG. 4, the liquid crystal cell capacitors 112 connected to the dummy line are respectively charged with positive, negative, negative, positive . . . values through the dummy line.

This embodiment implements the inversion driving of the line 1 after charging each liquid crystal cell capacitor 112. Specifically, the line 1 is driven while the liquid crystal cell capacitors 112 that are connected to the source lines S1, S3 and so on in the odd rows are on charge, and only the liquid crystal cell capacitors 112 that are connected to the source lines S2, S4 and so on in the even rows are inverted. Therefore, the liquid crystal cell capacitors 112 where write defect is likely to occur are only those connected to the source lines S2, S4 and so on in the even rows. This prevents that the line 1 is recognized as horizontal stripes.

It is apparent that the present invention is not limited to the above embodiment that may be modified and changed without departing from the scope and spirit of the invention.

What is claimed is:

1. A driving method for a display apparatus including a plurality of pixels arranged in matrix along a line direction and a column direction, implementing sequential driving in the column direction by inverting a polarity of a plurality of pixels arranged in the line direction, the method comprising:
driving a plurality of pixels arranged in an odd line; and
driving a plurality of pixels arranged in an even line and in a column different from a column of the plurality of driven pixels in the odd line.

2. The driving method for a display apparatus according to claim 1, wherein
the driving of a plurality of pixels arranged in an even line drives pixels arranged in a column adjacent to the plurality of driven pixels in the odd line.

3. The driving method for a display apparatus according to claim 1, wherein
the driving of a plurality of pixels arranged in an odd line drives a plurality of pixels arranged per pixel, and
the driving of a plurality of pixels arranged in an even line drives a plurality of pixels arranged between the plurality of driven pixels.

4. The driving method for a display apparatus according to claim 2, wherein
the driving of a plurality of pixels arranged in an odd line drives a plurality of pixels arranged per pixel, and
the driving of a plurality of pixels arranged in an even line drives a plurality of pixels arranged between the plurality of driven pixels.

5. The driving method for a display apparatus according to claim 1, wherein
the pixels are display pixels used for displaying a picture on the display apparatus, and the display apparatus includes a plurality of dummy pixels arranged in the line direction and different from the display pixels, the driving method further comprising:
driving the plurality of dummy pixels prior to driving a plurality of pixels arranged in the odd line.

6. The driving method for a display apparatus according to claim 2, wherein
the pixels are display pixels used for displaying a picture on the display apparatus, and the display apparatus includes a plurality of dummy pixels arranged in the line direction and different from the display pixels, the driving method further comprising:
driving the plurality of dummy pixels prior to driving a plurality of pixels arranged in the odd line.

7. The driving method for a display apparatus according to claim 3, wherein
the pixels are display pixels used for displaying a picture on the display apparatus, and the display apparatus includes a plurality of dummy pixels arranged in the line direction and different from the display pixels, the driving method further comprising:
driving the plurality of dummy pixels prior to driving a plurality of pixels arranged in the odd line.

8. The driving method for a display apparatus according to claim 4, wherein
the pixels are display pixels used for displaying a picture on the display apparatus, and the display apparatus includes a plurality of dummy pixels arranged in the line direction and different from the display pixels, the driving method further comprising:
driving the plurality of dummy pixels prior to driving a plurality of pixels arranged in the odd line.

9. A display apparatus comprising:
a plurality of pixels arranged in matrix along a line direction and a column direction;
a plurality of driver connected to the plurality of pixels and capable of driving the plurality of pixels; and
a controller for driving a plurality of pixels arranged in the line direction sequentially in the column direction by inverting a polarity of the pixels, the controller driving a plurality of pixels arranged in an odd line, and driving a plurality of pixels arranged in an even line and in a column different from a column of the plurality of driven pixels in the odd line.

10. The display apparatus according to claim 9, wherein
the controller drives pixels arranged in a column adjacent to the plurality of driven pixels in the odd line.

11. The display apparatus according to claim 9, wherein
the controller drives a plurality of pixels arranged per pixel and drives a plurality of pixels arranged between the plurality of driven pixels.

12. The display apparatus according to claim 10, wherein
the controller drives a plurality of pixels arranged per pixel and drives a plurality of pixels arranged between the plurality of driven pixels.

13. The display apparatus according to claim 9, wherein
the pixels are display pixels used for displaying a picture on the display apparatus,
the display apparatus includes a plurality of dummy pixels arranged in the line direction and different from the display pixels, and
the controller drives the plurality of dummy pixels prior to driving a plurality of pixels arranged in the odd line.

14. The display apparatus according to claim 10, wherein
the pixels are display pixels used for displaying a picture on the display apparatus,
the display apparatus includes a plurality of dummy pixels arranged in the line direction and different from the display pixels, and
the controller drives the plurality of dummy pixels prior to driving a plurality of pixels arranged in the odd line.

15. The display apparatus according to claim 11, wherein
the pixels are display pixels used for displaying a picture on the display apparatus,
the display apparatus includes a plurality of dummy pixels arranged in the line direction and different from the display pixels, and
the controller drives the plurality of dummy pixels prior to driving a plurality of pixels arranged in the odd line.

16. The display apparatus according to claim 12, wherein
the pixels are display pixels used for displaying a picture on the display apparatus,
the display apparatus includes a plurality of dummy pixels arranged in the line direction and different from the display pixels, and
the controller drives the plurality of dummy pixels prior to driving a plurality of pixels arranged in the odd line.
